(19) United States
(12) Patent Application Publication
(10) Pub. No.: US 2007/0258696 A1
(43) Pub. Date: Nov. 8, 2007

(54) Digital video recorder (DVR) filtering of on-screen graphics

(76) Inventors: Michael J. Branson, Rochester, MN (US); Gregory R. Hintermeister, Rochester, MN (US)

Correspondence Address: IBM CORPORATION, 3605 HIGHWAY 52 NORTH, DEPT 917, ROCHESTER, MN, 55901-7829, US

(21) Appl. No.: 11/397,545

(22) Filed: Apr. 4, 2006

(51) Int. Cl. H04N 5/93

(52) U.S. Cl. 386/52

(57) ABSTRACT

A method and digital video recorder (DVR) mechanism that (1) filters out added graphical content that a user/viewer does not wish to view during live feed and/or playback of a recorded program, (2) adds graphical content to a live feed and/or recorded program, and (3) enables manipulation of graphical content for display with live feed and/or recorded programs. The logic/functionality of the DVR is enhanced to include features/functionality that allows the viewer to filter/add/manipulate certain graphical content (and its associated audio) from/to/within the program being displayed on the display screen. The received broadcast content contains identifying information about the graphical content, separate from the identifying information of the program content that that would allow the DVR functionality to identify and filter out certain (or all) aspects of the graphics. Different types of graphical content have different identifiers, so that the viewer is able to selectively filter out or add or manipulate one type of graphical content independent of the other(s).

### BACKGROUND OF THE INVENTION

1. Technical Field

The present invention relates generally to digital video recorders (DVRs) and in particular to enhancement of DVRs to enable user manipulation of digital content.

2. Description of the Related Art

Digital Video Recorders (DVRs) are utilized more and more to record streams of multimedia content that can be later played back on a television or other display device. In today's commercialized environment, where advertising plays a large part of all media outlets, the world of television has become inundated with advertisements and banner ads. In Addition to these advertisements, however, occasionally, the television programs are increasingly filling the screen with graphics to provide the watcher with more information, either about what they are watching or about some other event occurring that has absolutely no relationship (or very little) to the program being shown.

During sporting events, for example, graphics are often used extensively to annotate the event. Using golf as an example, while the golf tournament is being shown, a graphic may be displayed on the upper right hand side of the screen providing information about how long the player's last shot had traveled, the wind direction, and other kinds of information. While some viewers may find this information to be informative, many other viewers consider this display of information right on top of the screen to be annoying and would prefer to not have such graphics provided. As another example, oftentimes the news ticker is displayed running across the bottom of the screen during one of the non-news programs. Again, while some people like having this ticker available to read while they watch another program, other viewers find the ticker annoying.

Other examples of graphical content that are often displayed, to the annoyance of the viewer are: (a) the 30 minute updates of sports scores that shrink and distort the image of the sporting event begin shown; (b) the test of the emergency broadcast system that may pop up and distort the video and sound of any program currently being watched or recorded; (c) the stock price ticker; (d) the phone number of a banner type advertisement that the program wants you to dial; and (e) the storm warning graphic and radar that pops up during the show being watched or recorded.

Many people today record shows that are broadcasted and watch these shows at a later time. When these shows are recorded to the DVR, the entire content that is broadcasted is automatically recorded, including the advertisements, banners, and many of the above list of other annoying displays. While it is easy to fast forward through the advertisements, there is currently no way to avoid having the recorded program also display the various interruptions and miscellaneous displays during play back of the recorded program. Not only is this playback annoying, but in the case where the playback is not immediate (in relative time to the original program), the displayed “news” on the ticker is now “old news” and/or the weather alert is no longer valid.

### SUMMARY OF THE INVENTION

Disclosed is a method and digital video recorder (DVR) mechanism that (1) filters out added graphical content that a user/viewer does not wish to view during live feed and/or playback of a recorded program, (2) adds graphical content to a live feed and/or recorded program, and (3) enables manipulation of graphical content for display with live feed and/or recorded programs. The logic/functionality of the DVR is enhanced to include features/functionality that allows the viewer to filter/add/manipulate certain graphical content (and its associated audio) from/to/within the program being displayed on the display screen. The received broadcast content contains identifying information about the graphical content, separate from the identifying information of the program content that that would allow the DVR functionality to identify and filter out certain (or all) aspects of the graphics. Different types of graphical content have different identifiers, so that the viewer is able to selectively filter out or add or manipulate one type of graphical content independent of the other(s).

In one embodiment, a menu option is provided, that is accessible via the DVR's remote control or menu button on the device itself. Once the menu option is selected, the user has the option to select what types (using the identifiers) of graphical content to remove from the relay of stored program content. The user may select one or more of the graphical content or an “all” option for all of the identified graphical content for removal.

In another embodiment, the user of the DVR may utilize this feature during one of several different ways, allowing the user to customize what graphical content is displayed. Among these methods of utilizing the feature are: (1) selecting a special filter button (new button added to the remote) while viewing a program in real-time (to filter out graphics as they pop up); (2) pre-setting the DVR to filter out such graphics when recording a program. In one alternate embodiment, the DVR may be set to filter out graphics that is time-pertinent and which would no longer be relevant when the recorded content is being watched at a later time/date (e.g., weather warning); (3) pre-setting the DVR to filter out the graphic when saving to another media (e.g. saving recorded program to a DVD) so as to remove the graphics from an archived copy of the program; and (4) filtering out the graphics during actual playback of the program, where the graphic remains on the actual recorded version but is not displayed during playback.

In one embodiment, the DVR functionality is utilized to add certain graphical content to a program that is being displayed, even where the original program content/broadcast does not include the graphical content. For example, the use of added graphical display may be utilized to provide real-time news or scores ticker on a recorded program. One implementation of this embodiment involves retrieving from the current broadcast feed real-time information on a particular ticker and displaying that real time information on the recorded program currently being watched. Thus, is the viewer is watching a recorded program or one that has been paused and is thus lagging behind real-time, the ticker that was shown on the recorded/delayed program is replaced on screen with a ticker that is up-to-date. In a second implementation, the graphical content is added to a program that is being watched in real time or a recorded program, which did not include any graphical content originally. This latter embodiment enables overlapping of graphical content from a different source feed (e.g., CNN) over a program being broadcast from a different source (e.g., NBC).

In an extension of the original embodiment, the viewer may be allowed to change the location of a graphic on the screen in real-time and/or during playback. Additionally, one embodiment utilizes the concept of “skins” (typically provided with multimedia players) whereby the filter is able to arrange (or re-arrange) the graphics in a number of named variations supported by the DVR. Finally, another embodiment enables substitution of advertising found on graphics with different advertising each time a recording is viewed. This enables dynamic update of graphics content from the source, which may be an internet feed, the broadcast feed, or other source connected to the DVR.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1A, 1B and 1C provide a block schematic of a digital broadcast stream, a digital video recorder and remote within which the features of the invention may advantageously be implemented;

FIG. 2 is a flow chart illustrating the process of selectively blocking graphics content during DVR recording according to one embodiment of the invention in accordance with one embodiment;

FIG. 3A is a flow chart illustrating the process of selectively blocking graphics content during playback according to one embodiment of the invention; and

FIG. 3B is a flow chart illustrating the process of selectively blocking and/or adding and/or manipulating graphics content during real-time and/or playback, according to embodiments of the invention.

### DETAILED DESCRIPTION OF AN ILLUSTRATIVE EMBODIMENT

The present invention provides a method and digital video recorder (DVR) mechanism that (1) filters out added graphical content that a user/viewer does not wish to view during live feed and/or playback of a recorded program, (2) adds graphical content to a live feed and/or recorded program, and (3) enables manipulation of graphical content for display with live feed and/or recorded programs. The logic/functionality of the DVR is enhanced to include features/functionality that allows the viewer to filter/add/manipulate certain graphical content (and its associated audio) from/to/within the program being displayed on the display screen. The received broadcast content contains identifying information about the graphical content, separate from the identifying information of the program content that that would allow the DVR functionality to identify and filter out certain (or all) aspects of the graphics. Different types of graphical content have different identifiers, so that the viewer is able to selectively filter out or add or manipulate one type of graphical content independent of the other(s).

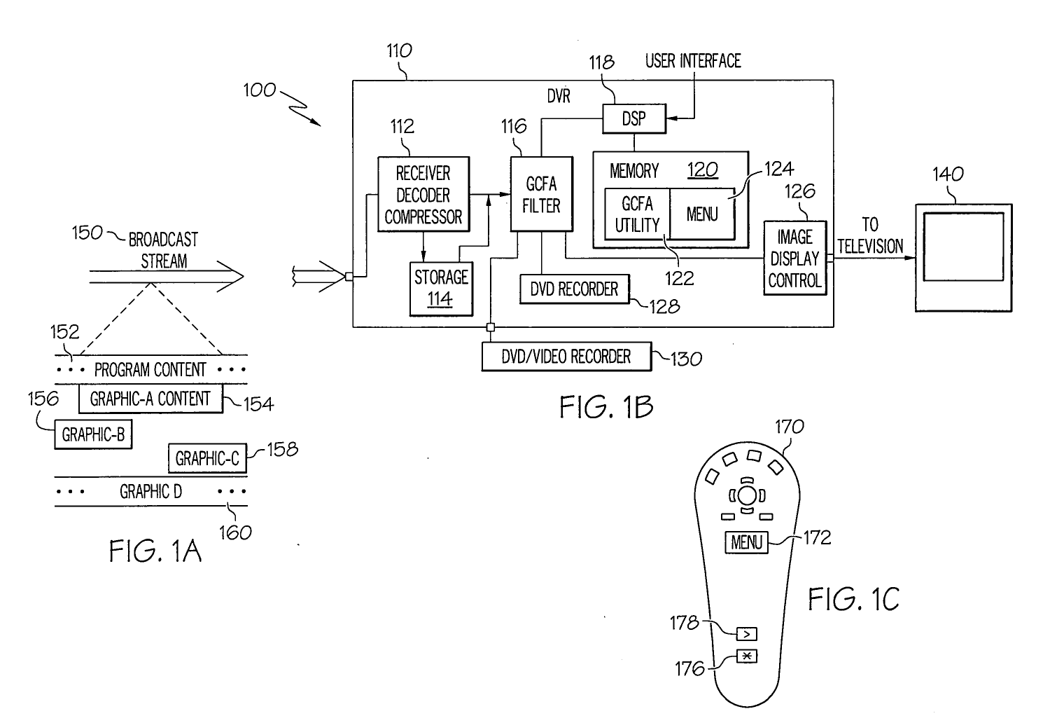

Referring now to FIGS. 1A, 1B and 1C, which illustrate DVR subsystem 100 comprising an example DVR 110 couples to a broadcast stream 150 at its input node(s) and to an output device (television) 140 at its output node. As illustrated, DVR 110 comprises several internal components, including a receiver/decoder/compression component 112 (which may be individual components in other representations), an image display controller 126 for transmitting video (and audio) content to the television 140, a digital signal processor 118 which servers as the processing “brain” of the DVR, storage 114, within which the recorded programs are stored, and a memory 120. Additionally, DVR 110 comprises a graphics content filter and/or adder (GCFA) 116, which enables the filtering and adding of graphics contents as described below. GCFA 116 represents a component for recognizing and/or distinguishing the graphical content from within the digital stream so that DVR graphics filter functionality is able to filter out such graphical content, either in real-time or during later playback.

Finally, DVR 110 provides for input/output devices, such as user interface (not specifically shown) and an on-board DVD recorder 128 to which stored content may be archived on DVD ROMS. The user interface may be buttons on the surface of the DVR 110 as well as wireless connectivity to DVR remote controller 170. It is understood that DVR 110 illustrated herein is merely an example device and that many different (and obviously more complex) configurations of devices exist and/or are being designed within which the features of the invention may be implemented. The DVR 110 illustrated herein is solely to aid in the description of the invention and not meant to imply any limitations on the invention.

Notably, in addition to the above described hardware components of DVR 110, various features of the invention are provided as software logic (i.e., functional code) stored within memory 120 or other storage (114) and executed by DSP 118 or other processing component (not shown). Menu functionality, as described below, is provided via a menu utility (code) 124. For simplicity, the collective body of code that enables the various DVR graphic filtering and addition functions is referred to hereinafter as graphical content filter and/or addition (GCFA) utility 122.

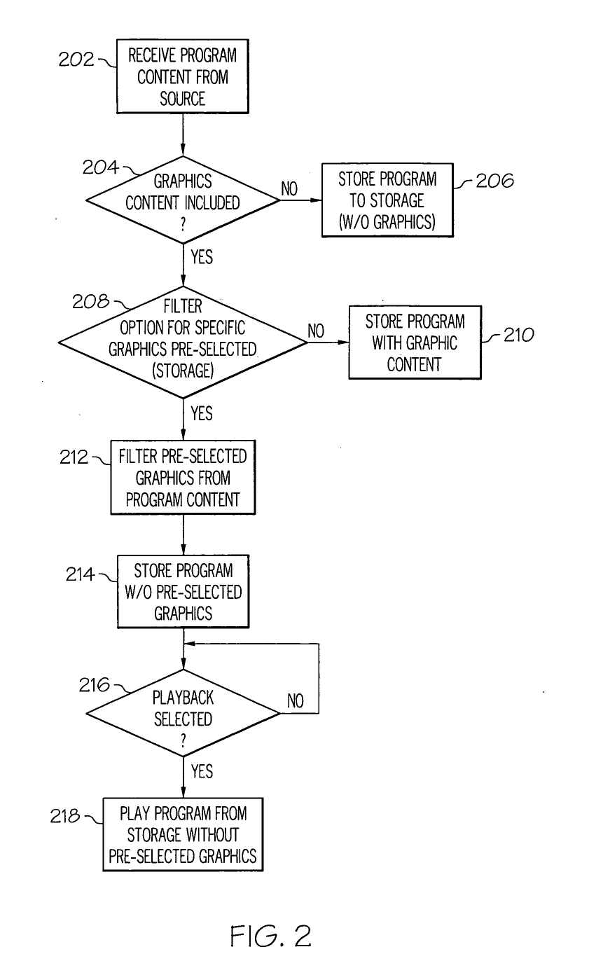

FIG. 2 illustrates the process steps completed by the DVR during program storage and specifically implemented via the GCFA utility 122 executing on the DSP 118, in one embodiment. As shown by block 202, the process is initiated when the program content is received from the source. As provided in FIG. 1, program content 152 is provided within a broadcast stream 150, which also includes other program content and, more specifically one or more graphical content. Several graphical contents are illustrated, namely graphic-A 154, graphic-B 156, graphic-C 158, and graphic-D 160. Notably, the first three graphics are time constrained relative to the program (i.e, they are shown for only a short period of time), while the fourth graphic, graphic D 160, is a continuous stream that runs for a longer period of time. The CNN ticket at the bottom of the screen is an example of graphic D 160. Any one (or more) of these graphics may be displayed during the broadcast or playback of the program content 152.

Returning to FIG. 2, when the content is received at the DVR 110, the DSP first determines at block 204 if there is any graphic included with the program content. If there is no graphic, the program content is stored within storage 114, as shown at block 206. If there is graphic within the received program content, a next determination is made at block 208 whether the filter option has been pre-selected for the particular type of graphic.

This determination assumes a pre-selection by the user of particular types of graphic to exclude from storage. The manner in which this pre-selection occurs is now described. In one embodiment of the invention, a menu option is provided, that is accessible via the DVR's remote control menu button 172 or a menu button on the device itself. Depressing the menu button 172 activates the menu functionality of the device provided by the menu utility 124. In the present invention, the menu options are augmented to include a list of GCFA selections provided by the GCFA utility 122. While shown as a separate utility, it is understood that GDFA utility 122 may be a sub-routine or sub-component of menu utility 124. Once the menu option is selected, the user has the option to select what types (using the identifiers) of graphical content to remove/filter from (or add to) the program content received (or stored or played back). For example, the user may select one or more of the types of graphical content listed or an “all” option for all of the identified graphical content for removal from the stored (or playback) copy of the program.

The user of the DVR 110 may activate/utilize this GCFA feature in one of several different ways, each allowing the user to customize what graphical content is displayed. Among these methods of utilization are: (1) selecting a special filter button 176 (see new filter button 176 added to the remote 170 of FIG. 1) while viewing a program in real-time (to filter out graphics as they pop up); (2) pre-setting the DVR to filter out such graphics when recording a program. In one alternate embodiment, the DVR may be set to filter out graphics that is time-pertinent and which would no longer be relevant when the recorded content is being watched at a later time/date (e.g., weather warning); (3) pre-setting the DVR to filter out the graphic when saving to another media (e.g. saving recorded program to a DVD) so as to remove the graphics from an archived copy of the program; and (4) filtering out the graphics during actual playback of the program, where the graphic remains on the actual recorded version but is not displayed during playback.

Returning again to FIG. 2, when no filter option is pre-selected for the device, the device stores the program along with all the graphic content, as indicated at block 210. However, when the filter option is pre-selected for specific graphics, the GCFA filter 116 is activated to remove the particular graphic from the received program content, as shown at block 212, and then the program is stored without the particular graphic, as provided at block 214. When this later storage is performed (i.e., with filtering of graphics) and it is determined at block 216 that playback is selected for the program, the program is played back without the pres-selected graphic, which has been removed prior to storage of the program, as stated at block 218.

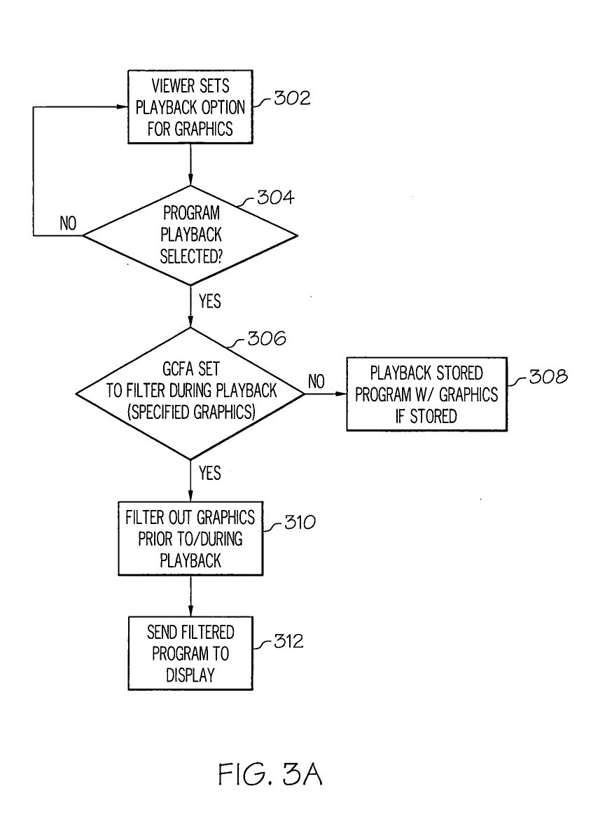

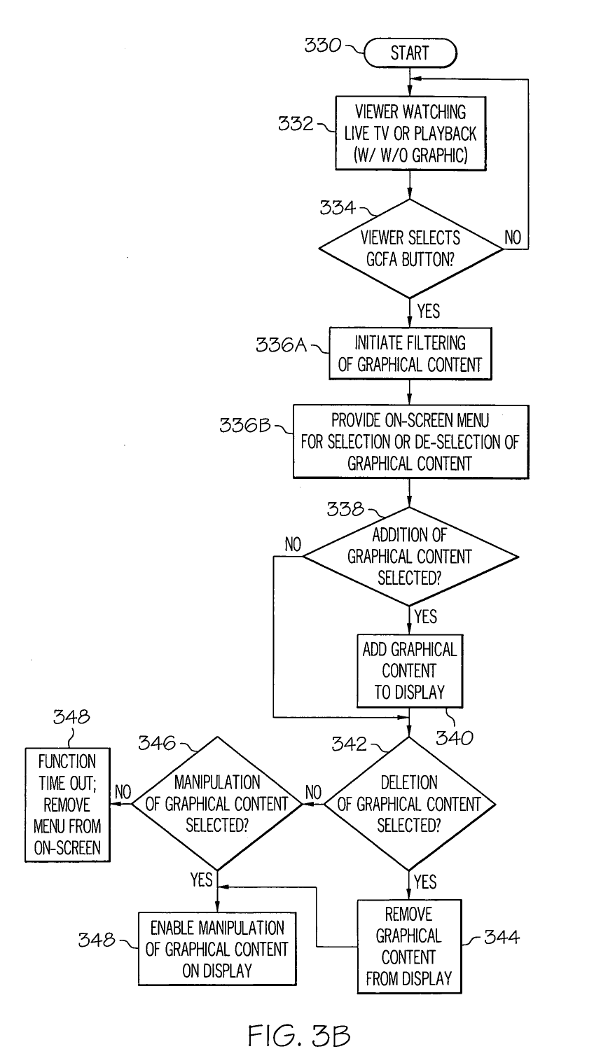

FIG. 3A illustrates the application of the features of the invention to the playback period (as opposed to the program storage period of FIG. 2). As shown, the process begins at block 302 at which the viewer sets specific playback options for graphics. As a specific example of the application of the invention, the user pre-sets graphics filter to turn off CNN's ticker by selecting to turn off graphics identified as “news graphics”. By selecting this menu option, the DVR provides a menu of graphics that may be part of the broadcast, and the viewer is then able to select which graphic should or should not be displayed. This selection may be a global selection (apply to all playback) or specific to the program being played back (where each programs graphics are individually accessible for manipulation, turning on/off, by the user).

Following, the device monitors at block 304 for initiation of playback of a recorded program. When playback is detected, the device determines at block 306 whether the GCFA filter is set to filter graphics (generally or specifically identified graphics) during the specific program. When the filter is not set for such filtering, the program is played back as stored (i.e., along with any graphics that were initially stored with the program), as provided at block 308. Otherwise, the GCFA filter 116 filters out the specific graphics prior to or during playback, as indicated at block 310. Then, the program is played back on the display without the graphics, as shown at block 312.

By the above process, all graphical content is broadcasted, and the DVR acts as a filter to remove those pre-selected by the user from the displayed content. Notably, this filtering of the graphical content may be done at any point in the life of the program on the DVR. Thus, the viewer is able to watch a program in real time with all graphical content turned on, then re-watch the same content and turn some of some or all of the graphical content at the beginning of the program or any time during the program replay.

Where not all graphical content is differentiated within broadcasted programs, the availability of this feature necessarily adds value to the DVR over the traditional DVR or other recording device. In one embodiment, programs could also be created and/or broadcasted to enable enhanced use of this feature to block out certain content of a program (e.g., nudity and or foul language) that is tagged with a particular identifier available for selection/de-selection in the menu of graphics. In this embodiment, the filtering of the unwanted content is provided via the DVR rather than a separate parental control device. These program (and the DVR) may then be advertised as including this feature, making the DVR more appealing to the user and such programs more likely to be recorded in a home where parental controls is enforced for both live and recorded programs, for example.

In one embodiment, the GCFA utility 122 (along with the GCFA filter 116) is utilized to add certain graphical content to a program that is being displayed, even where the original program content/broadcast does not include the graphical content. For example, the use of added graphical display may be utilized to provide real-time news or scores ticker on a recorded program. One implementation of this embodiment involves retrieving from the current broadcast feed real-time information on a particular ticker and displaying that real time information on the recorded program currently being watched. Thus, as the viewer is watching a recorded program or one that has been paused and is thus lagging behind real-time, the ticker that was shown on the recorded/delayed program is replaced on screen with a ticker that is up-to-date. In a second implementation, the graphical content is added to a program that is being watched in real time or a recorded program, which program did not include any graphical content originally. This latter embodiment enables overlapping of graphical content from a different source feed (e.g., CNN) over a program being broadcast from a different source (e.g., NBC). The implementation of this feature may require use of similar technology as the picture-in-picture (PIP) functionality available with DVRs and other recording devices.

As another example, with this real-time graphic feature, if the viewer is watching a recorded program and a real-time severe weather bulletin is broadcast for the viewer's area during the play back, the current severe weather bulletin is shown as a graphic over the playback so that the real-time information is displayed on the screen even though the viewer is watching a recorded program. The user pre-selects to receive such graphics in real time from the source using one of the menu options provided by the GFCA utility.

In an extension of the original embodiment, the viewer may be allowed to change the location of a graphic on the screen in real-time and/or during playback. Additionally, one embodiment utilizes the concept of “skins” (typically provided with multimedia players) whereby the filter is able to arrange (or re-arrange) the graphics in a number of named variations supported by the DVR. Finally, another embodiment enables substitution of advertising found on graphics with different advertising each time a recording is viewed. This enables dynamic update of graphics content from the source, which may be an internet feed, a broadcast feed, or other multimedia source to which the DVR is connected. The DVR user has the option of turning this option on or off, again using the menu selections provided via the GCFA utility.

FIG. 3B illustrates several of the above features within a process of playing back a stored program or viewing a program real-time, according to embodiments of the invention. The process begins at the start block 330 and proceeds to block 332 which shows the viewer watching television (either live TV or playback of a recorded program). The device monitors at block 334 for receipt of a signal indicting that the viewer has selected (depressed) the GFCA button (or alternatively has entered into the menu area for GFCA control). Once this button is selected, one of two responses is provided. In a first embodiment, the device automatically initiates the filtering of graphical content based on pre-set filters, as shown at block 336A. In a second embodiment, the device provides an on-screen menu for selection (de-selection) of graphical content, as shown at block 336B. From the display of the menu selection, a check is made at block 338 whether the viewer selects the option to add graphical content to the program. When this option is selected, graphical content is added to the display, as stated at block 340, via any number of methods for adding graphical content disclosed herein or which falls within the scope of the disclosed invention.

Following, a check is made at block 342, whether the user selects the option for deleting graphical content. When the user selects this option, graphical content is removed from the display, as stated at block 344, via any number of methods for removing graphical content disclosed herein or which falls within the scope of the disclosed invention. Finally, a check is made at block 346, whether the user selects the option to manipulate (move, resize, reformat, etc) the displayed graphical content. When the user selects this option, graphical content is manipulated accordingly when displayed on the display, as stated at block 348, via any number of methods for manipulating graphical content disclosed herein or which falls within the scope of the disclosed invention. One such method is to highlight or select the graphical display and utilize provided options (e.g., smaller, larger, left, right, top, bottom) to manipulate the display. These options may be selected via use of buttons on the remote control 170.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A digital video recorder (DVR) comprising:
means for receiving program content from a source;
a storage facility for storing the program content;
means for enabling separate identification and separation of a graphic from within the program content; and
means for manipulating graphic content by completing one or more of multiple available graphic functions from among: adding the graphic content to the program content wherein the program is content is received without the graphic and is forwarded to the display device with the added graphic; deleting the graphic content from the program content, wherein the graphic is received with the program content and when the graphic is not desired to be displayed along with the program content, said deleting comprises dynamically removing the graphic from the program content, wherein the received program content is forwarded from the DVR without the graphic that is removed; and changing the original graphic content relative to the program content, wherein the graphic content forwarded for displayed comprises different/changed display characteristics relative to the original graphic content and the program content.

2. The DVR of claim 1, wherein when the graphic is received along with the program content, said DVR further comprises:
means for enabling user selection of whether to store the program content with the graphic, wherein when the user selection is to not store the program content with the graphic, said program content is stored without the graphic.

3. The DVR of claim 1, wherein the graphic is not received along with the program content, said DVR further comprises:
means for adding a graphic to the program content that is forwarded for display, said means comprising means for receiving the graphic from a source and means for super-imposing the received graphic over the program content, said source being at least one of an internal media source and an external source.

4. The DVR of claim 1, wherein the graphic is not received at the same time as the program content and is forwarded for display at the same time as the program content.

5. The DVR of claim 1, further comprising:
a menu utility that selectively provides a displays of selectable options for selecting, de-selecting and manipulating graphic within displayed program content; and
means for enabling user activation of the menu utility and user selection of a desired option for displaying graphic within displayed program content.

6. The DVR of claim 5, further comprising:
means for receiving a remote selection of a DCFA button on a remote control configured with the DCFA button; and
means responsive to receipt of the remote selection for triggering an opening of the menu utility and enabling user selection of a desired option for displaying graphic within displayed program content.

7. A remote control unit for the DVR of claim 5, said remote control unit having a selectable button that when selected triggers an opening of the menu utility to enable user selection of a desired option for displaying graphic within displayed program content.

8. In a digital video recorder (DVR), a method comprising:
receiving program content from a source;
separately identifying and separating a graphic from within the program content; and
manipulating graphic content by completing one or more of multiple available graphic functions from among: adding the graphic content to the program content wherein the program is content is received without the graphic and is forwarded to the display device with the added graphic; deleting the graphic content from the program content, wherein the graphic is received with the program content and when the graphic is not desired to be displayed along with the program content, said deleting comprises dynamically removing the graphic from the program content, wherein the received program content is forwarded from the DVR without the graphic that is removed; and changing the original graphic content relative to the program content, wherein the graphic content forwarded for displayed comprises different/changed display characteristics relative to the original graphic content and the program content.

9. The method of claim 8, further comprising:
receiving the graphic along with the program content;
enabling user selection of whether to store the program content with the graphic within a storage facility of the DVR, wherein when the user selection is to not store the program content with the graphic, said program content is stored without the graphic.

10. The method of claim 8, wherein when the graphic is not received along with the program content, said method further comprises:
adding a graphic to the program content that is forwarded for display, said means comprising means for receiving the graphic from a source and means for super-imposing the received graphic over the program content, said source being at least one of an internal media source and an external source.

11. The method of claim 8, wherein the graphic is not received at the same time as the program content and said method comprises forwarding the graphic for display at the same time as the program content.

12. The method of claim 8, further comprising:
executing a menu utility that selectively provides a displays of selectable options for selecting, de-selecting and manipulating graphic within displayed program content; and
enabling user activation of the menu utility and user selection of a desired option for displaying graphic within displayed program content.

13. The method of claim 12, further comprising:
receiving a remote selection of a DCFA button on a remote control configured with the DCFA button; and
when the remote selection is received, triggering an opening of the menu utility and enabling user selection of a desired option for displaying graphic within displayed program content.

14. A remote control unit for activating the menu utility of the method of claim 12, said remote control unit having a selectable button that when selected triggers an opening of the menu utility to enable user selection of a desired option for displaying graphic within displayed program content.

15. A computer program product comprising:
a computer readable medium; and
program code on the computer readable medium that when executed by a processor within a digital video recorder provides the following functions:
receiving program content from a source;
separately identifying and separating a graphic from within the program content; and
manipulating graphic content by completing one or more of multiple available graphic functions from among: adding the graphic content to the program content wherein the program is content is received without the graphic and is forwarded to the display device with the added graphic; deleting the graphic content from the program content, wherein the graphic is received with the program content and when the graphic is not desired to be displayed along with the program content, said deleting comprises dynamically removing the graphic from the program content, wherein the received program content is forwarded from the DVR without the graphic that is removed; and
changing the original graphic content relative to the program content, wherein the graphic content forwarded for displayed comprises different/changed display characteristics relative to the original graphic content and the program content.

16. The computer program product of claim 15, further comprising program code for:
receiving the graphic along with the program content;
enabling user selection of whether to store the program content with the graphic within a storage facility of the DVR, wherein when the user selection is to not store the program content with the graphic, said program content is stored without the graphic.

17. The computer program product of claim 15, wherein when the graphic is not received along with the program content, said method further comprises program code for:
adding a graphic to the program content that is forwarded for display, said means comprising means for receiving the graphic from a source and means for super-imposing the received graphic over the program content, said source being at least one of an internal media source and an external source.

18. The computer program product of claim 15, wherein the graphic is not received at the same time as the program content and said method comprises program code for forwarding the graphic for display at the same time as the program content.

19. The computer program product of claim 15, further comprising program code for:
executing a menu utility that selectively provides a displays of selectable options for selecting, de-selecting and manipulating graphic within displayed program content; and
enabling user activation of the menu utility and user selection of a desired option for displaying graphic within displayed program content.

20. The computer program product of claim 19, further comprising program code for:
receiving a remote selection of a DCFA button on a remote control configured with the DCFA button; and
when the remote selection is received, triggering an opening of the menu utility and enabling user selection of a desired option for displaying graphic within displayed program content.
